(19) United States
(12) Patent Application Publication
(10) Pub. No.: US 2010/0287515 A1
(43) Pub. Date: Nov. 11, 2010

(54) INTERACTIVE CHECKER IN A LAYOUT EDITOR

(75) Inventors: ROBERT L. HEDMAN, ROCHESTER, MN (US); KARL L. LADIN, ROCHESTER, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES, CORPORATION, ARMONK, NY (US)

(21) Appl. No.: 12/436,236

(22) Filed: May 6, 2009

(51) Int. Cl. G06F 17/50

(52) U.S. Cl. 716/5

(57) ABSTRACT

Methods, articles of manufacture and apparatus for testing design layouts. Design layout software may be configured to display a layout diagram in a first area of a graphical user interface (GUI) screen. Parameters for testing the layout may be entered in a second area of the GUI screen. Upon receiving one or more test parameters, the layout software may be configured to identify portions of the layout that do not conform to design rules based on the test parameters.

### BACKGROUND OF THE INVENTION

1. Field of the Invention

The present invention generally relates to circuit design layout software, and more specifically to testing circuit design layouts using the software.

2. Description of the Related Art

Modern integrated circuits (ICs) include many thousands circuit components such as transistors, resistors, capacitors, inductors, and the like packed into a single die. As the demand for smaller, faster, and high performance ICs grows, more and more circuit components are packed into each die. Fabricating such densely packed ICs generally means that the circuit components are made smaller in size, placed very close to one another, or both.

However, in some cases, it may be necessary to form components having at least a minimum size to meet predefined performance parameters. Furthermore, placing some components too close to one another may be problematic as it may result in the components interfering with each others' operation. It may also be desirable to provide a sufficient gap between circuit components to avoid any defects that may occur during the fabrication of the IC. Therefore, IC designers generally must ensure that circuit components have at least a minimum size and minimum spacing therebetween.

### SUMMARY OF THE INVENTION

The present invention generally relates to circuit design layout software, and more specifically to testing circuit design layouts using the software.

One embodiment of the invention provides a computer implemented method for testing a layout comprising configuring one or more processors to perform an operation. The operation generally comprises providing a graphical user interface (GUI) screen comprising a diagram of the layout, the diagram comprising a plurality of components and a tool configured to receive input for scrolling through a predefined range of values. The operation further comprises receiving, via the tool, a value for a parameter from the predefined range of values, wherein the parameter defines a geometric rule for the plurality of components in the layout, and determining whether the plurality of components conform with the geometric rule defined by the parameter. Upon determining that one or more components do not conform with the geometric rule, the operation comprises visually distinguishing the one or more components in the diagram.

Another embodiment of the invention provides a computer readable storage medium comprising a program product which, when executed, is configured to perform an operation. The operation generally comprises providing a graphical user interface (GUI) screen comprising a diagram of the layout, the diagram comprising a plurality of components and a tool configured to receive input for scrolling through a predefined range of values. The operation further comprises receiving, via the tool, a value for a parameter from the predefined range of values, wherein the parameter defines a geometric rule for the plurality of components in the layout, and determining whether the plurality of components conform with the geometric rule defined by the parameter. Upon determining that one or more components do not conform with the geometric rule, the operation comprises visually distinguishing the one or more components in the diagram.

Yet another embodiment of the invention provides a system generally comprising a memory comprising a program and a processor. The processor, when executing the program, is generally configured to display a graphical user interface (GUI) screen comprising a diagram of a layout, the diagram comprising a plurality of components and a tool configured to receive input for scrolling through a predefined range of values. The processor is further configured to receive, via the tool, a value for a parameter from the predefined range of values, wherein the parameter defines a geometric rule for the plurality of components in the layout and determine whether the plurality of components conform with the geometric rule defined by the parameter. Upon determining that one or more components do not conform with the geometric rule, the processor is configured to visually distinguish the one or more components in the diagram.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system according to an embodiment of the invention.

FIGS. 2-4 illustrate an exemplary graphical user interface (GUI) screen according to an embodiment of the invention.

FIG. 5 is a flow diagram of exemplary operations performed by a design rules checker according to an embodiment of the invention.

### DETAILED DESCRIPTION OF THE PREFERRED EMBODIMENTS

The present invention generally relates to design layout software, and more specifically to testing design layouts using the software. The design layout software may be configured to display a layout diagram in a first area of a graphical user interface (GUI) screen. Parameters for testing the layout may be entered in a second area of the GUI screen. Upon receiving one or more test parameters, the layout software may be configured to identify portions of the layout that do not conform to design rules based on the test parameters.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Present day integrated circuits (IC) are designed using a variety of software tools, known as Design Automation tools. These tools encompass data entry capture, simulation, partitioning of logic, synthesis, wiring and placement, testing, etc. One of the tools which are deemed essential to the design of any IC product, whether a chip, module, card, board, frame, and the like, is known as a design rules checker. Design rules checking is the process of verifying that a mask layout of an integrated circuit does not violate a set of predefined geometrical design rules, also referred to as ground rules. These rules are, typically, determined by the manufacturing process used to fabricate the integrated circuit. Design rules are thus a collection of geometrical constraints among geometrical shapes that define the layout of an IC. It is presumed that a circuit design which obeys the design rules for a particular process should be manufacturable when using that process. Accordingly, design rules checking is an essential step in any IC design process.

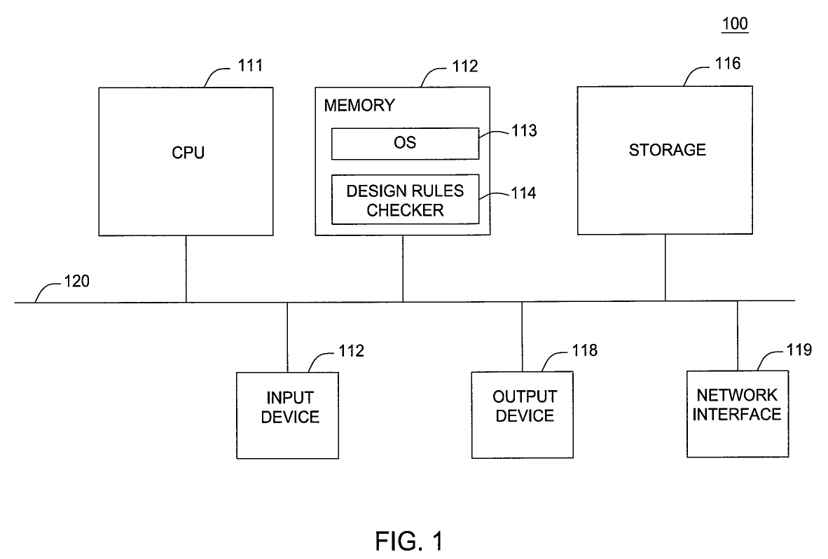

FIG. 1 depicts a block diagram of a system 100 in which embodiments of the invention may be implemented. In general, the system 100 includes a Central Processing Unit (CPU) 111 connected via a bus 120 to a memory 112, storage 116, an input device 117, an output device 118, and a network interface device 119. The input device 117 can be any device to give input to the system 100. For example, a keyboard, keypad, light-pen, touch-screen, track-ball, or speech recognition unit, audio/video player, and the like could be used.

The output device 118 can be any device to give output to the user, e.g., any conventional display screen. Although shown separately from the input device 117, the output device 118 and input device 117 could be combined. For example, a display screen with an integrated touch-screen, a display with an integrated keyboard, or a speech recognition unit combined with a text speech converter could be used.

The network interface device 119 may be any entry/exit device configured to allow network communications between the system 100 and one or more other systems via a network. For example, the network interface device 119 may be a network adapter or other network interface card (NIC).

Storage 116 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 112 and storage 116 could be part of one virtual address space spanning multiple primary and secondary storage devices.

The memory 112 is preferably a random access memory sufficiently large to hold the necessary programming and data structures of the invention. While memory 112 is shown as a single entity, it should be understood that memory 112 may in fact comprise a plurality of modules, and that memory 112 may exist at multiple levels, from high speed registers and caches to lower speed but larger DRAM chips.

Illustratively, the memory 112 contains an operating system 113. Illustrative operating systems, which may be used to advantage, include Linux (Linux is a trademark of Linus Torvalds in the US, other countries, or both) and Microsoft's Windows®. More generally, any operating system supporting the functions disclosed herein may be used.

Memory 112 is also shown containing a design rules checker program 114 which, when executed by CPU 111, provides support for verifying that an integrated circuit (IC) layout meets specified design rules. The design rules may include one or more parameters that define geometric restrictions for IC components. Exemplary design rules include width rules and spacing rules. In one embodiment, a width rule may establish a minimum width to ensure proper functioning of an IC component. For example, the width rule may establish a minimum width for a wire, conductive trace lines, or like conductors that connect two circuit elements. The minimum width may be calculated such that the conductor is able to transfer a desired amount of current between the components. The width rule may also be used to define minimum sizes for components such as transistor active regions, gate structures, and the like.

Spacing rules may establish a minimum distance between two or more components. The minimum distance may ensure that the two or more components do not interfere with each other. For example, some components may emit electromagnetic radiation which may result in signals of nearby components becoming noisy. By placing components at the minimum distance from one another, the effects of electromagnetic interference may be greatly reduced.

Embodiments of the invention are not limited only to minimum width rules and spacing rules. In alternative embodiments, maximum width and maximum spacing rules may also be defined. In some embodiments, other geometric rules, for example, minimum/maximum area rules, minimum/maximum volume rules, minimum/maximum angles, etc. may be defined. More generally, the design rules may include any set of rules that define the size, shape, and/or relative placement of components in a layout design.

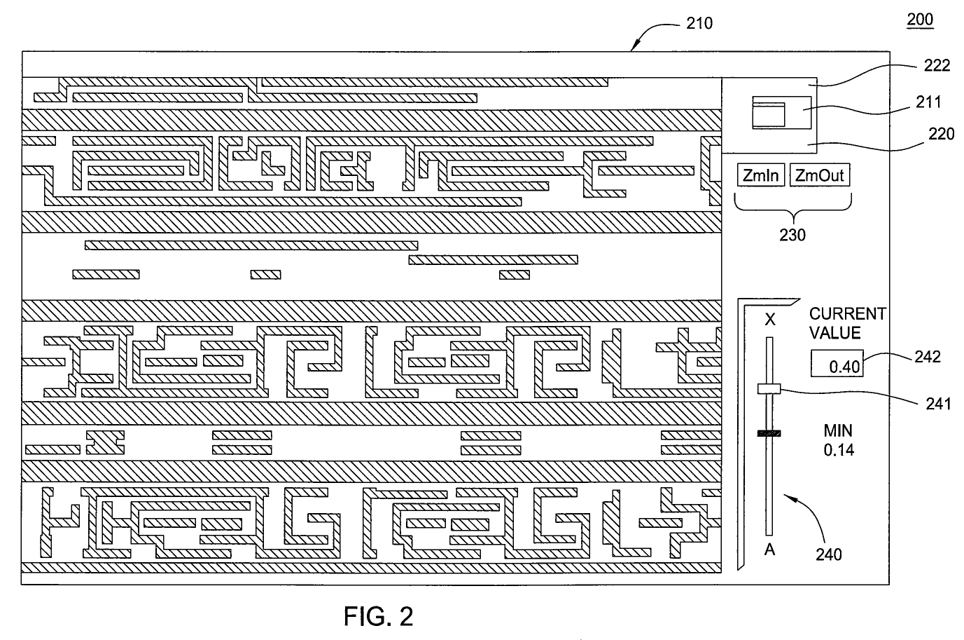

In one embodiment, the design rules checker program 114 may be configured to display, in a graphical user interface (GUI) screen, a layout diagram of an integrated circuit (IC) illustrating relative positions of one or more circuit components. FIG. 2 illustrates an exemplary GUI screen 200 that may be displayed by the design rules checker 114. As illustrated in FIG. 2, the GUI screen 200 may include a layout diagram 210, an IC overview screen 220, one or more control buttons 230, and a slider tool 240.

The layout diagram 210 may illustrate circuit components in a portion of the IC. The components may include resistors, capacitors, inductors, transistors, conductive traces, and the like. For example, the elements 211 in the layout diagram 210 may represent a conductive trace representing one of power and ground conductors. While a 2-dimensional view is illustrated in FIG. 2, in alternative embodiments, a 3-dimensional view of the IC may be illustrated in the layout diagram 210.

The overview screen 220 may indicate which portion of an IC 221 is currently displayed in the layout diagram 210. For example, the rectangle 222 may define the portion of the IC 211 that is currently displayed in the layout diagram 210. It may be possible for a user to move the rectangle 222 in the overview screen to view a more detailed view of the IC layout at a desired location. For example, a screen pointer such as, for example, a mouse pointer or stylus pen may be used to drag the rectangle to a desired location in one embodiment.

The control buttons 230 may allow a user to manipulate the view of the layout diagram 210. For example, a Zoom In button and a Zoom Out button are shown in FIG. 2. Clicking the zoom in and zoom out buttons may cause the view in the layout diagram 210 to either be magnified or miniaturized. If a 3-dimensional layout diagram is shown, the control buttons 230 may also include buttons to facilitate 3-dimensional rotation of the layout diagram 210.

The slider tool 240 may be used to input a testing parameter. The testing parameter may represent a design rule that is being tested with respect to an IC displayed in the layout diagram 210. For example, the slider tool 240 illustrates a range from A to X. The range A to X may represent any type of value including distance, area, volume, angle, etc. The location of a pointer or bar 241 in the slider tool 240 may indicate a particular testing parameter value selected in the range A to X. For illustrative purposes, the range A to X is hereinafter assumed to represent a component width.

Based on the location of the pointer 241 in FIG. 2, the value of the testing parameter is shown as 0.4 units as indicated in the text area 242. In one embodiment of the invention, a user may directly enter a desired testing parameter value in the text area 242. Upon entering a desired value in the text area 242, the pointer 241 may be moved to a location representing the entered value.

In one embodiment of the invention, the slider tool 240 may also include an indication of a threshold value for the parameter as defined by an IC design layout rule. In FIG. 2, the exemplary value of 0.14 units marked in the by the pointer 241 in the slider tool 240 may represent a threshold thickness value. In other words, a design rule may establish that the minimum acceptable component width in the layout diagram 210 is 0.14 units. Accordingly, the design rule may be visually provided to a user/tester in the slider tool 240, as illustrated in FIG. 2. In one embodiment, multiple threshold values may be shown in the slider tool 240. For example, an upper and lower threshold value may be defined for component thickness. Each of the multiple threshold values may be visually indicated in the slider tool 240.

In one embodiment of the invention, the testing parameter selected using the pointer 241 may establish the threshold value that is tested by the design rules checker 114. Illustratively, in the example shown in FIG. 2, design rules checker 114 may be configured to determine whether a component in the layout diagram has a width greater than the testing parameter value set by the pointer 241, and if not, identify the component as defective. In alternative embodiments, the testing parameter value may represent any other value including, for example, a maximum acceptable value or any other design threshold.

There may be several reasons to test different threshold values using the slider tool in addition to the threshold value established in the design rules. For example, while the threshold thickness value for components such as a conductive trace may be set to 0.14 in FIG. 2, a designer may want to relax the threshold to allow the conductor to carry greater current or to allow greater tolerance to fabrication defects. Accordingly, the designer may change the threshold to a more relaxed number greater than 0.14 to identify those locations in the IC layout that do not meet the relaxed threshold. The identified locations in the IC layout may then be modified to meet the new threshold value.

Providing a GUI based slider tool 240 may allow a user to determine whether an IC design layout meets one or more threshold values simply by sliding the pointer 241 to a desired location. In some embodiments, multiple slider tools 240 may be provided wherein each slider tool 240 is associated with a different threshold such as for example, a width threshold, spacing threshold, area threshold, and the like. A user may therefore be able to, with relative ease, determine whether a layout meets various combinations of design thresholds by simply moving pointers of respective slider tools to desired value locations.

While a slider tool 240 is illustrated as a means for receiving a testing parameter in FIG. 2, embodiments of the invention are not limited to slider tools. In one embodiment of the invention, a mouse scroll wheel (referred to hereinafter as a scroller) may be used to set the testing parameter. For example, moving the mouse scroller in a first direction may cause the testing parameter value in the text area 242 to continuously increase in relation to the movement, and moving the mouse scroller in a second direction may cause the testing parameter value in the text area 242 to continuously decrease in relation to the movement. A user may increase or decrease the testing parameter values until a desired testing parameter value is seen in the text area 242.

In one embodiment of the invention, the GUI 200 may include a tool for selecting a type of test to be performed. For example, a plurality of radio buttons may allow a user to select one of a component width check, component spacing check, and the like. Based on a type of test selected by the user, the range A to X on the slider tool 240 may be adjusted to reflect a respective range. Accordingly, a user may use a pointer 241 or a mouse scroller to enter appropriate parameters for a selected test.

Upon receiving a testing parameter value, the design rules checker 114 may be configured to determine whether the components in the layout diagram 240 conform to a threshold set by the testing parameter value. Components that do not conform to the threshold set by the testing parameter value may be identified in the layout diagram 210. For example, in one embodiment, the design rules checker 114 may determine whether the thickness of components is lesser than the testing parameter value. Components with a thickness less than the testing parameter value may be deemed defective and identified as such in the layout diagram.

As an example, in FIG. 2 a testing parameter value of 0.4 is provided. Because all components in the layout diagram may be less than 0.4 units in thickness, all components are shown with shading indicating that the components are defective. In some embodiments, defective components may be shown in a first color and the non-defective components may be shown in a second color in the layout diagram. For purposes of simplicity, defective and non-defective components are illustrated using hatches with a first slant and second slant respectively, in the drawings. For example, the hatches in FIG. 2 are shown with a first slant direction indicating that all components are defective. In alternative embodiments, any other visual indication may be provided to distinguish defective components from non-defective components.

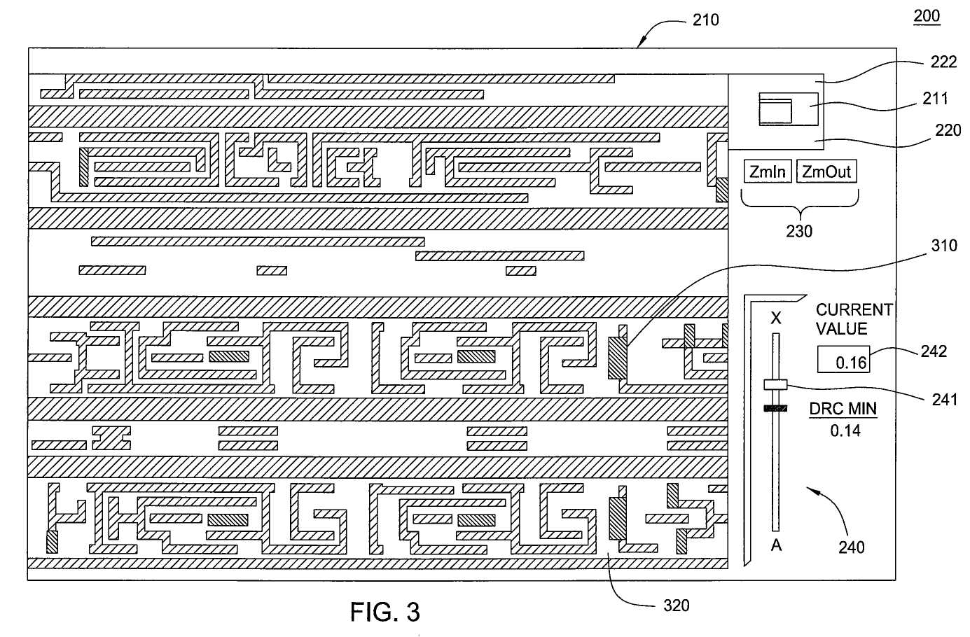

FIG. 3 illustrates the layout diagram 210 after the pointer 241 has been moved down to a value of 0.16 units. As illustrated in FIG. 3, one or more components 310 may be shown with hatches having a second slant, indicating that the components 310 would not be considered defective at the specified testing parameter value. One or more components 320 may have a component width less than 0.16 units. Accordingly, the components 320 are shown with hatches having the first slant, indicating that the items would be considered defective at the specified testing parameter value.

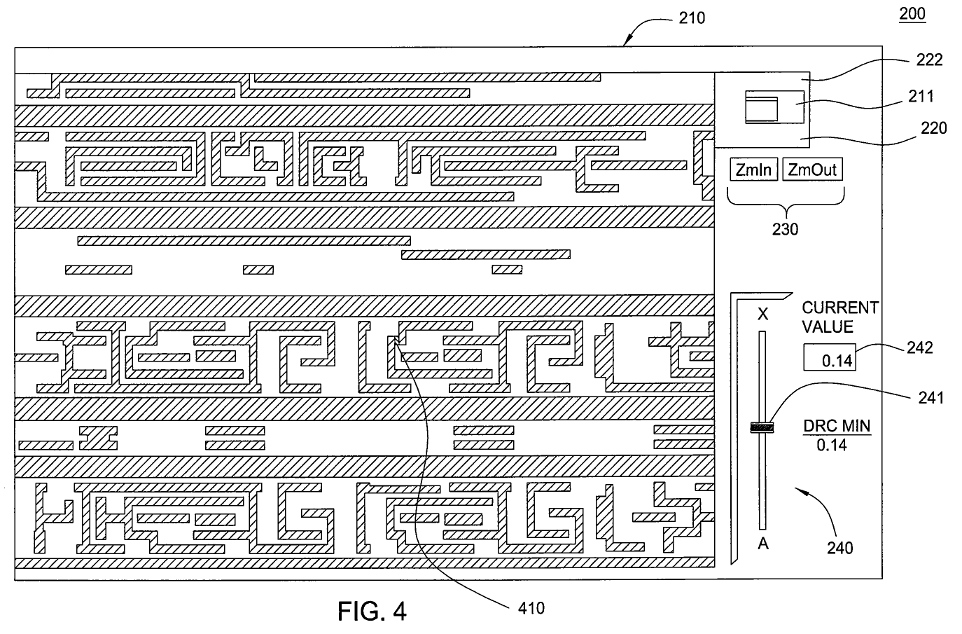

FIG. 4 illustrates the layout diagram 210 after moving the pointer 241 to a value of 0.14 units in the slider tool 240. As illustrated in the layout diagram 210, most of the components except the component 410 may be shown as conforming to the threshold set by the testing parameter. Because the 0.14 units is shown in the slider tool as a design rule, the layout diagram 210 may have to be modified to increase the width of the component 410.

While embodiments of the invention are described with reference to testing geometric restrictions for integrated circuit layouts, embodiments of the invention may also be used for testing any other type of layout. For example, layouts of drainage systems may be tested using embodiments of the invention to ensure that all pipes of the drainage system have at least a minimum acceptable width. In general, any type of layout comprising components that are to be formed with predefined geometric restrictions may be tested using embodiments of the invention.

By providing a graphical user interface that illustrates components of a layout diagram and a tool for entering testing parameter values, embodiments of the invention provide a user friendly method for testing the layout diagram with relative ease.

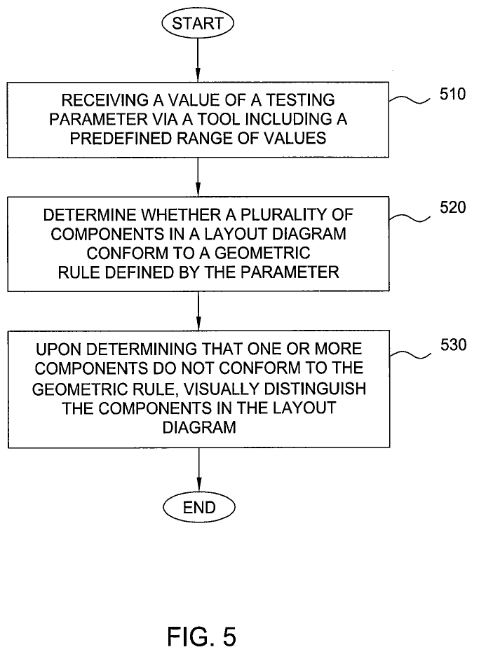

FIG. 5 is a flow diagram of exemplary operations performed by a design rules checker 114 according to an embodiment of the invention. The operations may begin in step 510 by receiving a value for a testing parameter via a tool including a predefined range of values. The parameter may define a geometric rule for the plurality of components in the layout. In step 520, the design rules checker 114 may determine whether a plurality of components in a layout diagram conform to a geometric rule defined by the parameter. Upon determining that one or more components do not conform to the geometric rule, the design rules checker 114 may visually distinguish the one or more components in the layout diagram.

While the foregoing is directed to embodiments of the present invention, other and further embodiments of the invention may be devised without departing from the basic scope thereof, and the scope thereof is determined by the claims that follow.

What is claimed is:

1. A computer implemented method for testing a layout comprising configuring one or more processors to perform an operation comprising:
providing a graphical user interface (GUI) screen comprising:
a diagram of the layout, the diagram comprising a plurality of components; and
a tool configured to receive input for scrolling through a predefined range of values;
receiving, via the tool, a value for a parameter from the predefined range of values, wherein the parameter defines a geometric rule for the plurality of components in the layout;
determining whether the plurality of components conform with the geometric rule defined by the parameter; and
upon determining that one or more components do not conform with the geometric rule, visually distinguishing the one or more components in the diagram.

2. The method of claim 1, wherein the tool comprises a slider defining the range of values and a pointer.

3. The method of claim 2, wherein receiving the value for the parameter comprises receiving a pointer event that moves the pointer to a location of the slider associated with the value.

4. The method of claim 1, wherein the tool comprises a text area illustrating a current value of the parameter.

5. The method of claim 4, wherein receiving the value of the parameter comprises receiving a mouse event comprising movement of a mouse scroller, the movement of the mouse scroller changing the value of the parameter in the text area.

6. The method of claim 1, wherein the tool comprises an indication of a threshold value for the parameter.

7. The method of claim 1, wherein the layout is associated with an integrated circuit design.

8. A computer readable storage medium comprising a program product which, when executed, is configured to perform an operation, comprising:
providing a graphical user interface (GUI) screen comprising:
a diagram of the layout, the diagram comprising a plurality of components; and
a tool configured to receive input for scrolling through a predefined range of values;
receiving, via the tool, a value for a parameter from the predefined range of values, wherein the parameter defines a geometric rule for the plurality of components in the layout;
determining whether the plurality of components conform with the geometric rule defined by the parameter; and
upon determining that one or more components do not conform with the geometric rule, visually distinguishing the one or more components in the diagram.

9. The computer readable storage medium of claim 8, wherein the tool comprises a slider defining the range of values and a pointer, and wherein receiving the value for the parameter comprises receiving a pointer event that moves the pointer to a location of the slider associated with the value.

10. The computer readable storage medium of claim 8, wherein the tool comprises a text area illustrating a current value of the parameter.

11. The computer readable storage medium of claim 10, wherein receiving the value of the parameter comprises receiving a mouse event comprising movement of a mouse scroller, the movement of the mouse scroller changing the value of the parameter in the text area.

12. The computer readable storage medium of claim 8, wherein the tool comprises an indication of a threshold value for the parameter.

13. The computer readable storage medium of claim 8, wherein the layout is associated with an integrated circuit design.

14. A system, comprising:
a memory comprising a program; and
a processor which, when executing the program, is configured to:
display a graphical user interface (GUI) screen comprising
a diagram of a layout, the diagram comprising a plurality of components; and
a tool configured to receive input for scrolling through a predefined range of values;
receive, via the tool, a value for a parameter from the predefined range of values, wherein the parameter defines a geometric rule for the plurality of components in the layout;
determine whether the plurality of components conform with the geometric rule defined by the parameter; and
upon determining that one or more components do not conform with the geometric rule, visually distinguish the one or more components in the diagram.

15. The system of claim 14, wherein the tool comprises a slider defining the range of values and a pointer.

16. The system of claim 15, wherein the processor is configured to receive the value for the parameter by receiving a pointer event that moves the pointer to a location of the slider associated with the value.

17. The system of claim 14, wherein the tool comprises a text area illustrating a current value of the parameter.

18. The system of claim 17, wherein the processor is configured to receive the value of the parameter by receiving a mouse event comprising movement of a mouse scroller, the movement of the mouse scroller changing the value of the parameter in the text area.

19. The system of claim 14, wherein the tool comprises an indication of a threshold value for the parameter.

20. The system of claim 14, wherein the layout is associated with an integrated circuit design.
